(19) United States
(12) Patent Application Publication
(10) Pub. No.: US 2014/0060979 A1
(43) Pub. Date: Mar. 6, 2014

(54) RAILCAR HANDBRAKE MONITOR

(71) Applicants: ANDREW MARTIN, WEST CHESTER, PA (US); ALLEN SMITH, MECHANICSBURG, PA (US)

(72) Inventors: ANDREW MARTIN, WEST CHESTER, PA (US); ALLEN SMITH, MECHANICSBURG, PA (US)

(73) Assignee: AMSTED RAIL COMPANY, INC., CHICAGO, IL (US)

(21) Appl. No.: 13/605,477

(22) Filed: Sep. 6, 2012

(51) Int. Cl. B60T 17/22; B61H 13/02

(52) U.S. Cl. 188/1.11 E

(57) ABSTRACT

A device for monitoring the status of a railcar handbrake having a hand operated handle, which device has a magnet configured to he inserted in the linkage of a railcar handbrake system. A sensing component is mounted on the railcar to sense the proximity of the magnet when the handbrake is applied. A system and method using the monitoring device to provide communication of an alarm when the handbrake is applied and the railcar is moving.

### BACKGROUND OF THE INVENTION

1. Field of the Invention

The present invention relates to a device, system and method for monitoring the status of a railcar handbrake, and for providing an alert when the car is in motion while the handbrake is applied.

2. Description of the Related Art

Wheel damage in the railroad industry is responsible for significant maintenance costs. A common cause of wheel damage is moving the railcar while the handbrake is applied. If the handbrake is applied when the railcar is moving, the wheels of that car will not turn. Instead, they will slide on the rail, resulting in damage to the wheels, e.g., slid flats, spalling, shelling, etc.

Each railcar typically has a brake rigging on the underside of the railcar that includes an arrangement of rods, levers and chains forming a mechanical linkage connected to brake shoes which can be applied to rub against the train wheels, using friction to slow and stop the train. This brake rigging can be operated by an air cylinder that is part of a centralized train air brake system controlled from a central location, e.g., the locomotive. The air brake system is used to slow and stop entire trains.

Most railroad cars also have manually-operated mechanical hand brake devices that can set and release the brakes. They are used to maintain railcars at rest such as When in the rail yard or at a customer site for loading and unloading. Manually operated handbrake devices typically operate at least a portion of the same brake rigging on the railcar used by the air brake system, bypassing the air cylinder to engage the brake shoes.

In one form, the handbrake has a manually operable hand wheel located on the end of the railcar. The hand wheel is attached through gearing to a rotatable axle which in turn is attached to a chain running down the side of the railcar. The gearing provides mechanical advantage allowing a person to operate the hand wheel. The chain may be directly connected, or via a rod, to a bell crank, or a shive wheel which in turn connects to a chain and top rod that runs under the undercarriage of the railcar, and which ultimately links to the brake rigging. Turning of the hand wheel turns the gear to gather up the chain around the axle, pulling the chain in tension and pivoting the bell crank, which in turn tensions the chain and top rod under the undercarriage of the railcar to operate the brake rigging, and thereby apply the brakes. Sufficient tension will prevent the wheels from turning. Turning the hand wheel in the opposite direction will release the brakes. Other forms of handbrakes include a hand lever that is operated manually to apply tension to the chain or rod that operates the brakes in a similar manner as described above.

Since a handbrake is specific to a single railcar, it is not uncommon for inspectors to overlook an individual railcar when checking to ensure that the handbrakes are released. Thus the railcar may be moved with the handbrakes applied.

### SUMMARY OF THE INVENTION

The present invention provides a device for monitoring the status of a railcar handbrake having a hand operated handle. The device includes a sensing component mounted near the railcar handbrake. A magnet is mounted on the handbrake bell crank or operating chain at a position such that when the handbrake is engaged, the mounted magnet is sensed by the sensing component. Accordingly, a prearranged level of magnetic field sensing by the sensing component will indicate that the handbrake is engaged. Alternatively, the sensing component can be located on the handbrake bell crank or chain and the magnet can be mounted on a railcar structure near the railcar hand brake. The status of the handbrake, on or off, can be communicated, such as by wireless transmission, to a site away from the railcar. A motion detection device can also be provided. If the hand brake is on and motion is detected, a signal providing an alarm of such condition can be transmitted.

The present invention also provides a method of monitoring and reporting the status of a railcar handbrake. The method includes the following steps: (a) sensing whether the handbrake is engaged via a sensor; (b) detecting motion of the rail car; and (c) if in step (b) it is determined that the brake is on, and in step (c) it is determined that the railcar is in motion, transmitting a signal indicating that the brake is on and the railcar is in motion.

### BRIEF DESCRIPTION OF THE DRAWINGS

In the drawings;

FIG. 1 is a schematic of a railcar and railcar handbrake system showing the brake rigging and handbrake, and the magnet for one embodiment of the handbrake sensing system;

FIG. 2 is a schematic view of one embodiment of the handbrake linkage showing the magnet for the handbrake sensing system connected thereto;

FIG. 3 is an end view of the handbrake sensing device of one embodiment of the present invention;

FIG. 3A is a schematic of the sensing circuit;

FIG. 4 is a side view of the handbrake sensing device shown in FIG. 3;

FIG. 5 is a perspective view of one embodiment of the handbrake sensing system showing the magnet and sensing component; and

FIG. 6 is a schematic view of an exemplary system for monitoring and reporting the status of a railcar handbrake of a railcar, in accordance with one embodiment of the present invention.

### DESCRIPTION OF PREFERRED EMBODIMENTS

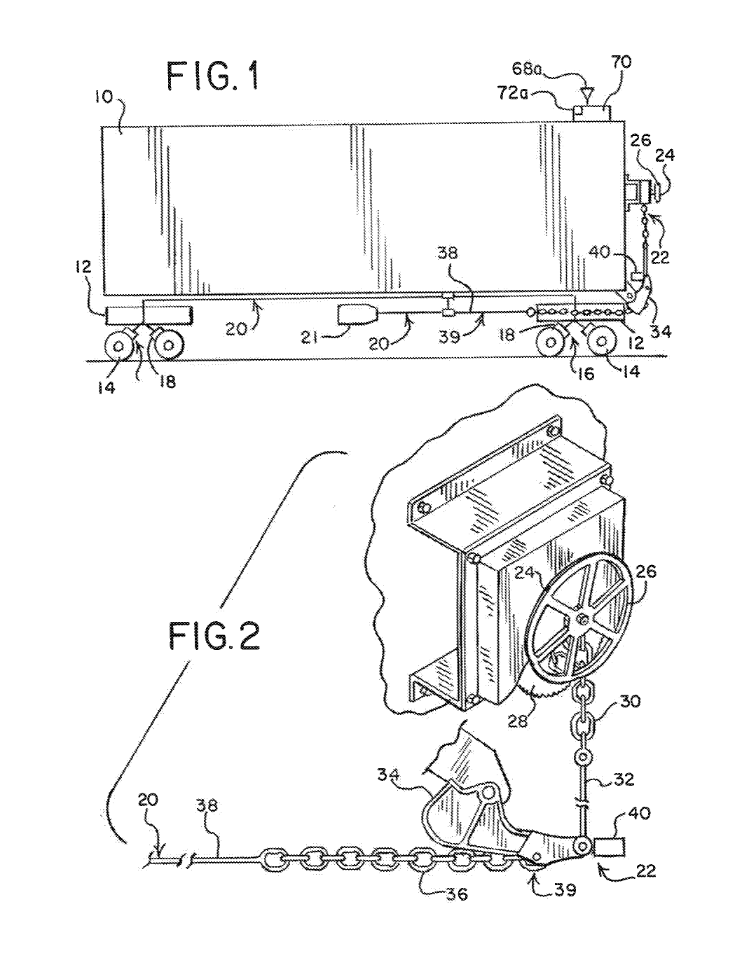

A typical railcar brake system that includes a handbrake monitoring device of the present invention is now described with reference to FIGS. 1 and 2. A railcar 10 has trucks 12 supported on railcar wheels 14 as is known in the art. Brakes 16, which include brake pads 18, are urged against the wheels 14 to apply a braking force. The brakes are moved into and away from the wheels by brake rigging 20 typically mounted underneath the railcar 10. The rigging can include rods, levers and chains that are moved to operate the brakes 16. Air brake systems typically include a pneumatic piston/cylinder unit 21 operatively linked to the rigging so that the brakes can be controlled from a central location, such as the locomotive, by directing compressed air to the pneumatic piston/cylinder unit to move the rigging. It is appreciated that the air brake system is an automated system allowing braking of all the railcars of a train from a single location, and is used for slowing and stopping the entire train.

A railcar manually-operated handbrake 22 allows railcar 10 to be held stationary even when separated from a train, and without use of the air braking system. Each railcar 10 would have its own handbrake, which typically includes a hand operated handle 24 attached to the end of the railcar 10. The handle 24 is typically a hand wheel 26 but can take other forms such as a hand operated lever. The handle 24 in this case includes a small gear (not shown) for driving a larger gear 28 which has an axle as is known in the art. The gearing ratio provides mechanical advantage allowing a person to operate the hand wheel. A chain 30 is connected to the axle so as to be capable of being wound around it upon rotation of the axle. The chain is connected to a rod 32 which in turn is connected to a bell crank 34 which converts the vertical movement of the chain 30 on the side of the railcar to horizontal movement underneath the railcar 10. A second chain 36 connected at one end to the bell crank 34 and at its other end to a tie rod 38 that is ultimately connected to the brake rigging 37. It is seen that manual rotation of the handle 24 in one direction pulls the chain 30 upwardly. This in turn rotates the bell crank 34 counterclockwise as shown in FIG. 2, which in turn moves the tie rod 38 rightward, thereby operating the brake rigging to engage the brakes 16. The various components connecting the handle 24 to the brake rigging 37, including the various chains and rods and bell crank, are referred to herein generally as the handbrake linkage 39. It is appreciated that turning of the handle 24 applies a force or tension to the linkage 39, which force is transferred through the linkage 39 to the brakes 16. The more force applied, the greater the braking force applied to the wheels 14. The exact configuration of the handbrake linkage 39 varies depending on the railcar. For example, in some railcars the handbrake will connect to the brake rigging so as to operate the wheels 14 of only one truck 12, not the wheels of both trucks as in other cars.

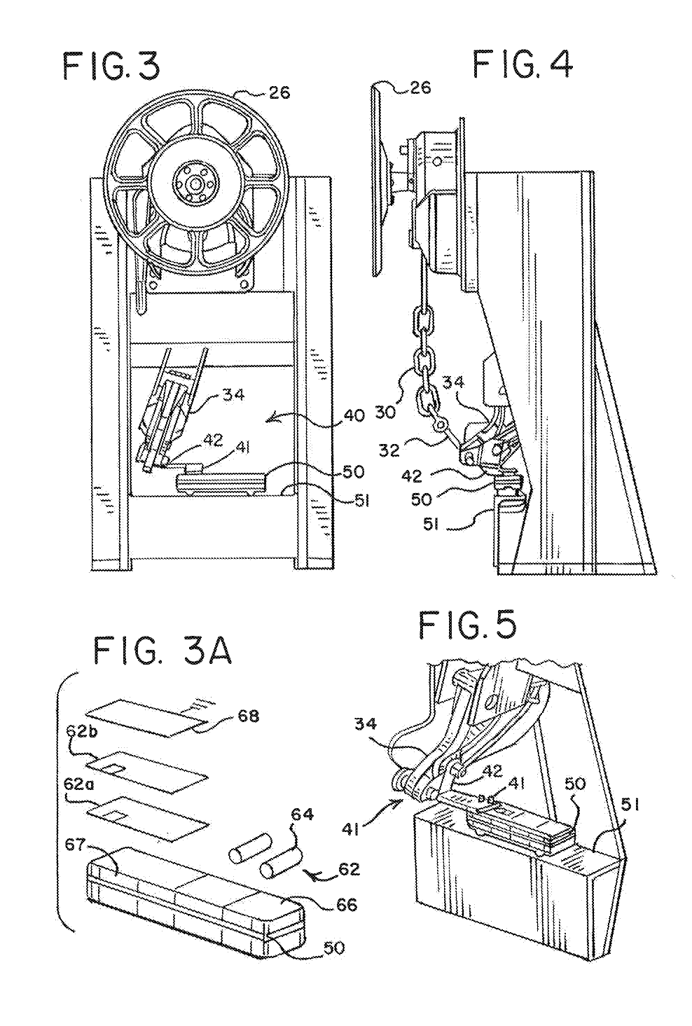

A component of brake monitoring device 40 in the form of a magnet is installed preferably on the handbrake bell crank 34. In the illustrated embodiment, and with further reference to FIGS. 3, 4 and 5, the monitoring device magnet 40 is a self contained unit that includes a support 42 affixed to and extending from bell crank 34. The actual magnet 41 is mounted near an end of support 42. For clarity, chain 30 is not shown in FIG. 3.

Sensing component 50 is mounted to a structure 51 formed at an end of railcar 10. Sensing component 50 includes electronic circuitry that senses the proximity of magnet 41. Sensing component 50 is positioned such that, upon handbrake 22 being applied thusly bringing magnet 41 into proximity to sensing component 50. The proximity of magnet 41, will be sensed by sensing component 50. In turn, a signal that the handbrake has been engaged will be sent by sensing component 50.

Electrical circuitry 62 is provided within sensing component 50 for determining the state of the handbrake. The electrical circuitry 62 includes the components and wiring to receive and process the proximity of magnet 41. This can include, but is not limited to, analog and digital circuitry, CPUs, processors, circuit boards, memory, controllers, and other electrical items, as required to sense the proximity of magnet 41, including communication circuitry and devices, GPS circuitry and devices, and motion detection circuitry and devices. In the illustrated embodiment, two circuit boards 62a and 62b are provided, hoard 62a having the magnetic field detection circuitry, board 62b the communications circuitry.

A power source such as batteries is part of 64 the electrical circuitry 62 for providing power thereto. Any suitable power source can be provided. In the preferred embodiment, the power source 64 is provided by two C cell lithium-thionyl chloride battery mounted in sensing device 50.

The preferred embodiment of sensing component 50 further includes a housing 66 supported on the railcar for housing the various components within it, e.g., the electrical circuitry 62 and power source 64. The housing is preferably weatherproof, and made of any suitable material such as a UV rated polymer. The various components are mounted and electrically connected within the housing 66. After the various components are installed within the housing, a potting material 67 is provided to fill the housing 66 to maintain, encapsulate and environmentally seal the components within. Any suitable electrical potting material capable of protecting the electric circuitry and components from the harsh railroad environment can be used, where harsh weather, vibration, mechanical impact, thermal shocks, UV exposure, humidity and abrasion might occur while the device is in operation. Such materials include epoxies, polyurethanes and silicone compounds. A flexible urethane suitable for electrical use and through which wireless signals of the frequencies to be used can be transmitted is preferred.

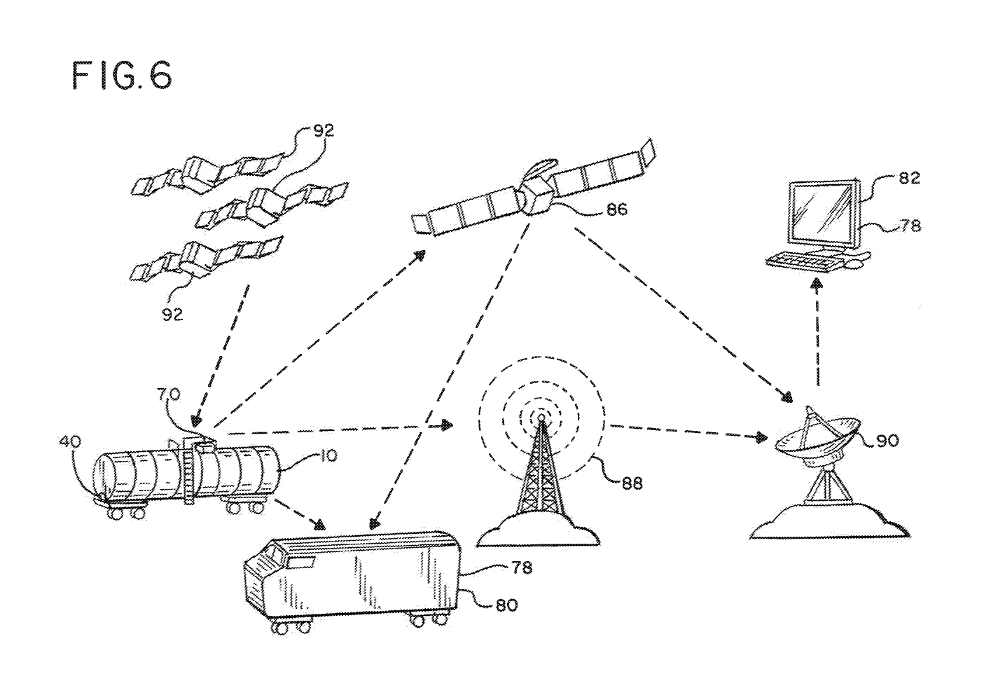

Referring to FIGS. 3A and 6, in one preferred embodiment, sensing component 50 forms part of a system for monitoring and reporting the status of the railcar handbrake. This requires the communication of information related to the status of the handbrake to a receiver in other places such as the locomotive 80, or a ground based computer system 82 where the information can be recorded, analyzed and reviewed or, if necessary acted upon. Accordingly, the present invention includes means to communicate information regarding the status of the handbrake. In one form, the means for communication include a wireless transmitter 68 mounted within sensing component 50 as part of the circuitry 62. For long life, it preferred to provide a low power Transmitter. Accordingly, rather than communicating directly with a satellite, cellular telephone system, or other far away receiver/transmitter, a communication management unit (CMU) 70, can be provided on the train 10, preferably on the railcar 10 itself (FIGS. 1. and 6). The term CMU 70 as used herein means any device capable of receiving information regarding the status of the handbrake from the monitoring device 40 and capable of transmitting the information related to the status of the handbrake to a receiver away from the railcar 10. Such a CMU is preferably a single unit that would serve as a communications link to other locations, such as the locomotive, ground monitoring station, etc., and have its own circuitry, CPUs, processors, memory, power source, etc. to process the data received. In a preferred embodiment, it can also communicate with, control and monitor other devices on the railcar 10. Such devices can include motion sensing devices, such as accelerometers, GPS devices, gyroscopes, tilt sensors, etc.

The brake monitoring device 40 can transmit information to the CMU 70 via the wireless communication device 68, or by hardwire. Where a wireless device is used in the monitoring device 40 for communicating with the CMU 70, an ultra low power device operating in the 2.4 GHz frequency band is preferred. Means to register the monitoring device 40 with the CMU 70 so that the monitoring device 40 is recognized by the CMU are known in the art.

An example of a preferred system and method of monitoring and reporting the status of a railcar handbrake is now described with reference to FIG. 6. The method places sensing component 50 on the railcar so as to be capable of sensing the presence of magnet 41 mounted on bell crank 34. The electrical circuit 62, is capable of sensing the proximity of magnet 41 when the handbrake is applied. If it is determined that the brake 16 is on, a signal can be sent from communication device 68 indicating that the brake is on. The brake monitoring device 40 as described above can carry out this method. Although a basic preferred system and method has been described, it is appreciated that additional and more advanced steps are possible.

An additional step can include detecting motion of the railcar 10. This can be done with a motion detection device 72 such as an accelerometer or GPS located in the brake monitoring device 40, such as part of the electrical circuitry 62. If it is determined that the brake 16 is on and motion is detected, a signal/alarm indicating that the brake is on and the railcar is in motion can be transmitted either to the CMU 70 for further processing and/or transmission to the end receiver 78, e.g., locomotive 80 or customer ground based computer system 82. The circuitry 62 of the monitoring device 40 can include the necessary components to make this determination. As discussed above, the motion detection device can be alternatively located in the CMU 70. In such an embodiment, information that the brake is on is communicated from the monitoring device 40 to the CMU. If motion is detected by the CMU 70, and the CMU received a communication from the monitoring device 40 indicating that the brake is on, then the CMU would transmit a signal/alarm indicating that the brake is on and the railcar 10 is in motion.

The transmission of the status of the handbrake 22 to the end receiver 78 can be by any known means, e.g., via satellite 86, cell phone system 88, etc. If the transmission is to be sent to the locomotive 80, a direct transmission from the CMU 70 or monitoring device 40 could be used, although due to power requirements, it is preferred in the illustrated embodiment to have the monitoring device 40 transmit low power signals to the CMU.

The monitoring device 40 is preferably installed anywhere in the handbrake mechanism.

In operation, the monitoring device 40 can sample the sensing component 50 intermittently to preserve power and increase battery life. For example, in one embodiment the monitoring device 40 powers up every 30 seconds to read the strain gauge 60. Any other sample period can be used, e.g., 5 second periods are used in another embodiment.

If the brake monitoring device 40 senses that the handbrake is applied, and railcar motion is detected, a signal/alarm is transmitted. Where the motion detector is included in the CMU 70, the information indicating that the handbrake is on is communicated from the monitoring device 40 to the CMU 70, via wired or wireless transmission. If the CMU 70 determines that the railcar 10 is in motion, with both conditions now satisfied brake is on and railcar motion detected, the signal/alarm is sent to the desired receiving location 78. The alarm is preferably transmitted using various known means. There are various means to detect motion, one example using a GPS system 92 to monitor for movement of the railcar a certain distance, such as 50 feet upon which the railcar is considered to be in motion.

As discussed above, the present invention provides a handbrake monitoring device, system and method. One key feature and advantage is the ability to monitor the handbrake and, if it is determined that the handbrake is on and the railcar is in motion, a signal/alarm is sent warning that corrective action is required. Also, regular samples of the status of the brake can be made and transmitted. In a preferred embodiment, the monitoring device can work with a CMU, but it is contemplated that the monitoring device can contain the suitable components to act as an individual unit.

What is claimed is:

1. A system for monitoring and reporting the status of a railcar handbrake of a railcar, comprising:
a brake that engages a railcar wheel, the handbrake being operable by applying force thereto to increase a tension of the handbrake against the wheel;
a hand operated handle mounted on the railcar and which is operable to apply the force to the handbrake;
a linkage component connecting the handle to the handbrake and through which the three is applied by the handle to the handbrake; and
a device for monitoring the status of the railcar handbrake, the device including a magnet inserted in the linkage component, and a sensing component mounted on the railcar;
electrical circuitry in the sensing component for detecting the proximity of the magnet and thusly the status of the handbrake; and
a power source electrically connected to the electrical circuitry for providing power thereto.

2. A system for monitoring and reporting the status of a railcar handbrake in accordance with claim 1, further comprising:
a communication management unit mounted on the railcar, said communication unit being in communication with the sensing device for receiving information therefrom, said communication management unit having a wireless communication device for broadcasting information about the status of the railcar handbrake.

3. A system for monitoring and reporting the status of a railcar handbrake in accordance with claim 2, wherein the device for monitoring the status of the railcar handbrake includes a wireless communication device for transmitting information about the status of the handbrake.

4. A system for monitoring and reporting the status of a railcar handbrake in accordance with claim 1 wherein the electrical circuitry is configured to determine whether the handbrake is applied, and if so, broadcast information to the communication management unit indicating that the handbrake is applied.

5. A system for monitoring and reporting the status of a railcar handbrake in accordance with claim 4 wherein the device for monitoring the status of the railcar brake includes the magnet positioned on a bell crank of the linkage component.

6. A method of monitoring and reporting the status of a railcar handbrake wherein the railcar handbrake includes a manually operated handle connected to a brake via a linkage and wherein the handle is manually operated to apply a force to the linkage for engaging the brake, the method comprising the following steps:
(a) sensing whether the handbrake is applied by a sensing component determining the proximity of a magnet;
(b) detecting motion of the rail car by use of a motion detector; and
(c) if in step (a) it is determined that the brake is on, and in step (b) it is determined that the railcar is in motion, transmitting an alarm.

7. A method of monitoring and reporting the status of a railcar handbrake in accordance with claim 6 wherein step (a) is carried out by a sensing component mounted on the railcar detecting the proximity of a magnet mounted on a bell crank of the linkage.

8. A method of monitoring and reporting the status of a railcar handbrake in accordance with claim 6 wherein step (a) is carried out by a sensing device attached to the linkage, detecting the proximity of a magnet mounted on the railcar.
